(19) United States
(12) Patent Application Publication
(10) Pub. No.: US 2021/0200230 A1
(43) Pub. Date: Jul. 1, 2021

(54) CONDITIONAL BEHAVIOR PREDICTION FOR AUTONOMOUS VEHICLES

(71) Applicant: Waymo LLC, Mountain View, CA (US)

(72) Inventor: Stephane Ross, San Jose, CA (US)

(21) Appl. No.: 17/131,527

(22) Filed: Dec. 22, 2020

Related U.S. Application Data
(60) Provisional application No. 62/954,281, filed on Dec. 27, 2019.

(51) Int. Cl. G05D 1/02; G05D 1/00; B60W 60/00

(52) U.S. Cl. CPC G05D 1/0221; G05D 1/0088; B60W 2554/4044; G05D 2201/0213; B60W 2556/10; B60W 60/0027

(57) ABSTRACT

Methods, systems, and apparatus, including computer programs encoded on a computer storage medium, for conditional behavior prediction for agents in an environment. Conditional behavior predictions are made for agents navigating through the same environment as an autonomous vehicle that are conditioned on a planned future trajectory for the autonomous vehicle, e.g., as generated by a planning system of the autonomous vehicle.

### CROSS-REFERENCE TO RELATED APPLICATION

This application claims priority to U.S. Provisional Application No. 62/954,281, filed on Dec. 27, 2019. The disclosure of the prior application is considered part of and is incorporated by reference in the disclosure of this application.

### BACKGROUND

This specification relates to autonomous vehicles.

Autonomous vehicles include self-driving cars, boats, and aircraft. Autonomous vehicles use a variety of on-board sensors and computer systems to detect nearby objects and use such detections to make control and navigation decisions.

### SUMMARY

This specification describes a system implemented as computer programs on one or more computers in one or more locations that generates behavior prediction data for agents in the vicinity of an autonomous vehicle that is conditioned on a planned trajectory for the autonomous vehicle.

Particular embodiments of the subject matter described in this specification can be implemented so as to realize one or more of the following advantages.

Conventional behavior prediction systems predict future trajectories for vehicles and other agents in the vicinity of an autonomous vehicle. These predictions can then be used to make and update driving decisions for the autonomous vehicle. However, the predictions made by these conventional systems fail to account for how a given agent will react to the planned future trajectory of the autonomous vehicle. For example, some conventional systems predict the future behavior of the autonomous vehicle and then predict how other agents will react to this predicted future behavior. However, these predictions may not match any of the various planned trajectories that the planning system of the autonomous vehicle is considering.

The described systems, on the other hand, effectively interact with a behavior prediction system to cause the predictions made by the behavior prediction system to account for the planned trajectory of the autonomous vehicle. This results in more accurate trajectory predictions and, in turn, on more accurate driving decisions being made by the control and planning systems for the autonomous vehicle. Moreover, an existing behavior prediction system can be used to make conditional behavior predictions even though the existing system is not configured to consider planned trajectories when making predictions.

Additionally, the described systems can generate multiple conditional predictions for the same agent under different (alternate) planned trajectories for the autonomous vehicle. This enables the planning system for the autonomous vehicle to select better planned trajectories that better interact with other agents.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example on-board system.

FIG. 2 is a flow diagram of an example process for generating conditional behavior prediction data.

FIG. 3 is a flow diagram of another example process for generating conditional behavior prediction data.

Like reference numbers and designations in the various drawings indicate like elements.

### DETAILED DESCRIPTION

This specification describes how an on-board system of an autonomous vehicle can generate conditional behavior prediction data that characterizes the future trajectory of a target agent in the vicinity of the autonomous vehicle. The target agent can be, for example, a pedestrian, a bicyclist, or another vehicle. To generate the conditional behavior prediction data, the on-board system causes a behavior prediction system to generate the behavior prediction data conditioned on a planned trajectory of the autonomous vehicle. Unlike a predicted trajectory, the planned trajectory is generated by a planning system of the autonomous vehicle and is used to control the vehicle. In other words, at any given time, the control system of the autonomous vehicle controls the vehicle to follow the currently planned trajectory of the autonomous vehicle.

In some cases, the system can obtain, i.e., receive or generate, multiple different possible planned trajectories for the autonomous vehicle and then generate respective conditional behavior prediction data for each of the multiple different possible trajectories. This allows a planning system of the autonomous vehicle to take into consideration how various agents in the environment will change behavior if the autonomous vehicle takes different trajectories when determining the final planned trajectory of the autonomous vehicle at any given time.

The on-board system can use the conditional behavior prediction data to perform actions, i.e., to control the vehicle, which cause the vehicle to operate more safely. For example, the on-board system can generate fully-autonomous control outputs to apply the brakes of the vehicle to avoid a collision with a merging vehicle if the behavior prediction data suggests the merging vehicle is unlikely to yield comfortably when conditioned on a planned trajectory where the autonomous vehicle accelerates to pass ahead of the merging vehicle.

These features and other features are described in more detail below.

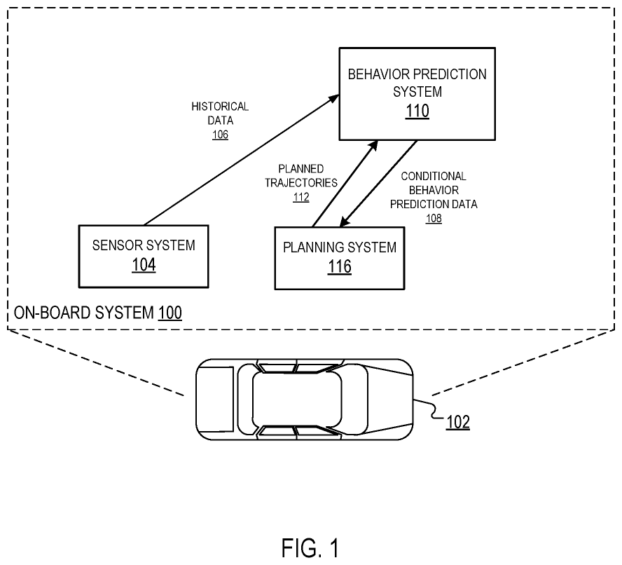

FIG. 1 is a block diagram of an example on-board system 100. The on-board system 100 is composed of hardware and software components, some or all of which are physically located on-board a vehicle 102. In some cases, the on-board system 100 can make fully-autonomous or partly-autonomous driving decisions (i.e., driving decisions taken independently of the driver of the vehicle 102), present information to the driver of the vehicle 102 to assist the driver in operating the vehicle safely, or both. For example, in response to determining that another vehicle is unlikely to yield for the vehicle 102, the on-board system 100 may autonomously apply the brakes of the vehicle 102 or otherwise autonomously change the trajectory of the vehicle 102 to prevent a collision between the vehicle 102 and the other vehicle.

Although the vehicle 102 in FIG. 1 is depicted as an automobile, and the examples in this document are described with reference to automobiles, in general the vehicle 102 can be any kind of vehicle. For example, besides an automobile, the vehicle 102 can be a watercraft or an aircraft. Moreover, the on-board system 100 can include components additional to those depicted in FIG. 1 (e.g., a collision detection system or a navigation system).

The on-board system 100 includes a sensor system 104 which enables the on-board system 100 to “see” the environment in the vicinity of the vehicle 102. More specifically, the sensor system 104 includes one or more sensors, some of which are configured to receive reflections of electromagnetic radiation from the environment in the vicinity of the vehicle 102. For example, the sensor system 104 can include one or more laser sensors (e.g., LIDAR laser sensors) that are configured to detect reflections of laser light. As another example, the sensor system 104 can include one or more radar sensors that are configured to detect reflections of radio waves. As another example, the sensor system 104 can include one or more camera sensors that are configured to detect reflections of visible light.

The sensor system 104 continually (i.e., at each of multiple time points) captures raw sensor data which can indicate the directions, intensities, and distances travelled by reflected radiation. For example, a sensor in the sensor system 104 can transmit one or more pulses of electromagnetic radiation in a particular direction and can measure the intensity of any reflections as well as the time that the reflection was received. A distance can be computed by determining the time which elapses between transmitting a pulse and receiving its reflection. Each sensor can continually sweep a particular space in angle, azimuth, or both. Sweeping in azimuth, for example, can allow a sensor to detect multiple objects along the same line of sight.

The on-board system 100 can use the sensor data continually generated by the sensor system 104 to track the trajectories of agents (e.g., pedestrians, bicyclists, other vehicles, and the like) in the environment in the vicinity of the vehicle 102. The trajectory of an agent refers to data defining, for each of multiple time points, the spatial position occupied by the agent in the environment at the time point and characteristics of the motion of the agent at the time point. The characteristics of the motion of an agent at a time point can include, for example, the velocity of the agent (e.g., measured in miles per hour—mph), the acceleration of the agent (e.g., measured in feet per second squared), and the heading of the agent (e.g., measured in degrees). The heading of an agent refers to the direction of travel of the agent and can be expressed as angular data (e.g., in the range 0 degrees to 360 degrees) which is defined relative to a given frame of reference in the environment (e.g., a North-South-East-West frame of reference).

To track the trajectory of an agent in the environment in the vicinity of the vehicle 102, the on-board system 100 can maintain (e.g., in a physical data storage device) historical data 106 defining the trajectory of the agent up to the current time point. The on-board system 100 can use the sensor data continually generated by the sensor system 104 to continually update (e.g., every 0.1 seconds) the historical data 106 defining the trajectory of the agent. Generally, at a given time point, the historical data 106 includes data defining: (i) the respective trajectories of agents in the vicinity of the vehicle 102, and (ii) the trajectory of the vehicle 102 itself, up to the given time point.

Historical data characterizing the trajectory of an agent can include any appropriate information that relates to the past trajectory and current position of the agent. For example, the historical data can include, for each of multiple time points, data defining a spatial position in the environment occupied by the agent at the time point. For each time point, the historical data can further define respective values of each motion parameter in a predetermined set of motion parameters. The value of each motion parameter characterizes a respective feature of the motion of the agent at the time point. Examples of motion parameters include: velocity, acceleration, and heading. In some implementations, the system further obtains data characterizing a candidate future trajectory of the target agent, and predicted future trajectories of the one or more other agents. The predicted future trajectories of the other agents may be defined by behavior prediction outputs which were previously generated by the system for the other agents.

The on-board system 100 can use the historical data 106 to generate, for one or more of the agents in the vicinity of the vehicle 102, respective conditional behavior prediction data 108 which predicts the future trajectory of the agent.

The on-board system 100 can continually generate conditional behavior prediction data 108 for agents in the vicinity of the vehicle 102, for example, at regular intervals of time (e.g., every 0.1 seconds). In particular, the conditional behavior prediction data 108 for any given agent identifies a future trajectory that the agent is predicted to follow in the immediate future, e.g., for the next five or ten seconds after the current time point.

To generate conditional behavior prediction data 108 for a target agent in the vicinity of the vehicle 102, the on-board system 100 uses a behavior prediction system 110.

The behavior prediction system 110 receives scene data that includes the historical data 106 that characterizes the agents in the current scene in the environment and generates trajectory predictions for some or all of the agents in the scene. In addition to the historical data 106, the scene data can also include other information that is available to the system 100 and that may impact the future behavior of agents in the environment. Examples of such information can include road graph information that identifies fixed features of the scene, e.g., intersections, traffic signs, and lane markers, and real-time scene information, e.g., the current state of any traffic lights in the scene.

To generate behavior prediction data 108 for the agents in the scene, the behavior prediction system 110 generates an initial representation of the future motion of the agents in the scene using the scene data, e.g., by applying likelihood models, motion planning algorithms, or both, to at least the historical data 106. The behavior prediction system 110 then generates, for each agent, the trajectory prediction for the agent based on the initial representation of the future motion, i.e., to account for possible interactions between agents in the scene in the future time period. For example, the behavior prediction system 100 can predict, for each agent in the scene, multiple candidate future trajectories and a respective likelihood score for each candidate future trajectory that represents the likelihood that the candidate future trajectory will be the actual future trajectory that is followed by the agent. Any of a variety of multi-agent behavior prediction systems can be employed as the behavior prediction system 110. One example of such a system is described in Rhinehart, et al, PRECOG: PREdiction Conditioned On Goals in Visual Multi-Agent Settings, arXiv:1905.01296.

Conventionally, the on-board system 100 would provide the behavior prediction data generated by the behavior prediction neural network 114 for the agents in the vicinity of the vehicle to a planning system 116.

When the planning system 116 receives the behavior prediction data 108, the planning system 116 can use the behavior prediction data 108 to make fully-autonomous driving decisions, i.e., to update a planned trajectory for the vehicle 102.

For example, the planning system 116 can generate a fully-autonomous plan to navigate the vehicle 102 to avoid a collision with another agent by changing the future trajectory of the vehicle 102 to avoid the agent. In a particular example, the on-board system 100 may provide the planning system 116 with behavior prediction data 108 indicating that another vehicle which is attempting to merge onto a roadway being travelled by the vehicle 102 is unlikely to yield to the vehicle 102. In this example, the planning system 116 can generate fully-autonomous control outputs to apply the brakes of the vehicle 102 to avoid a collision with the merging vehicle.

The fully-autonomous driving decisions generated by the planning system 116 can be implemented by a control system of the vehicle 102. For example, in response to receiving a fully-autonomous driving decision generated by the planning system 116 which indicates that the brakes of the vehicle should be applied, the control system may transmit an electronic signal to a braking control unit of the vehicle. In response to receiving the electronic signal, the braking control unit can mechanically apply the brakes of the vehicle.

Thus, during the operation of the vehicle 102, the planning system 116 maintains and repeatedly updates a planned trajectory for the vehicle 102. This planned trajectory is used to control the vehicle, i.e., the planned trajectory defines the driving decisions that are implemented by the control system in order to control the vehicle 102.

Conventionally, the behavior prediction system 110 would not consider any planned trajectories of the vehicle 102 in generating the behavior prediction data 108, i.e., because the other agents in the environment do not have access to the planned trajectory for the vehicle 102. However, not using the planned trajectory prevents the behavior prediction data generated by the behavior prediction system 110 from reflecting how other agents will likely react as the agents observe the vehicle 102 following the planned trajectory or how the other agents may react to different planned trajectories for the vehicle 102. The techniques described in this specification, on the other hand, allow the system to effectively leverage the planned trajectory or trajectories to modify behavior predictions made by the system 110.

In particular, using the techniques described in this specification, the planning system 116 can generate a planned trajectory 112 or multiple candidate planned trajectories 112 for the vehicle 102 and obtain, in response to each trajectory 112, a corresponding conditional behavior prediction 108 that characterizes predicted future trajectories of the other agents in the scene if the vehicle 102 follows the trajectory 112. Thus, the planning system 116 can evaluate the impact of multiple different possible planned trajectories 112 on the behavior of other agents in the scene as part of determining which planned trajectory to adopt as the final planned trajectory for the vehicle 102 at any given time.

As a particular example, the planning system 116 can be considering two planned trajectories at a particular time point: one in which the vehicle stays in the current lane and another in which the vehicle changes lanes to an adjacent lane. The on-board system can generate respective conditional behavior prediction data 108 for each of the candidate planned trajectories by querying the behavior prediction system using the two planned trajectories as described below. If the conditional behavior prediction data 108 indicates that staying in the current lane would result in another vehicle cutting off the vehicle 102, the planning system can be more likely to adopt the candidate trajectory in which the vehicle 102 changes lanes.

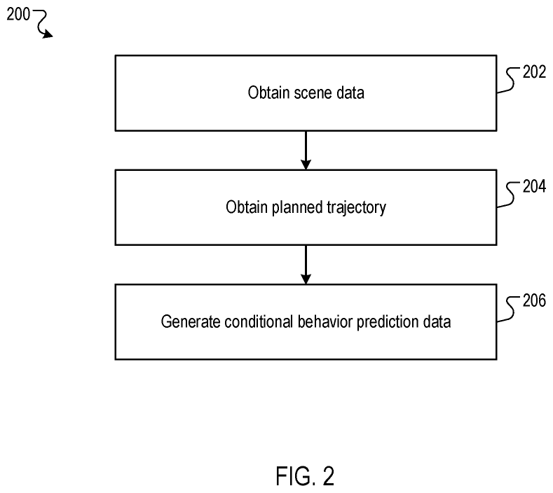

FIG. 2 is a flow diagram of an example process 200 for generating conditional behavior prediction data for a target agent. For convenience, the process 200 will be described as being performed by a system of one or more computers located in one or more locations. For example, an on-board system, e.g., the on-board system 100 of FIG. 1, appropriately programmed in accordance with this specification, can perform the process 200.

The system obtains scene data characterizing a scene in an environment at a current time point (202). The scene in the environment includes an autonomous vehicle navigating through the environment and one or more other agents including the target agent. The target agent can be, for example, another vehicle, a cyclist, a pedestrian, or any other dynamic object in the environment whose future trajectory may impact driving decisions for the autonomous vehicle.

The scene data generally includes historical data characterizing the previous trajectories of the agents in the environment up to the current time. This historical data characterizing the trajectory of an agent includes, for each of multiple time points, data defining a spatial position in the environment occupied by the agent at the time point. In some cases, for each time point, the historical data further defines respective values of each motion parameter in a predetermined set of motion parameters. The value of each motion parameter characterizes a respective feature of the motion of the agent at the time point. Examples of motion parameters include: velocity, acceleration, and heading. In some implementations, the system further obtains data characterizing a candidate future trajectory of the target agent, and predicted future trajectories of the one or more other agents.

The scene data can also include other information, e.g., road graph information or other information about the environment.

The system can then repeat steps 204 and 206 for each of multiple candidate trajectories that are generated by a planning system in order to allow the planning system to evaluate the potential impact of adopting each of the trajectories.

The system obtains data identifying a planned trajectory of the autonomous vehicle (step 204). In particular, the planned trajectory is generated by a planning system of the autonomous trajectory and identifies a planned path of the autonomous vehicle through the environment subsequent to the current time point, i.e., identifies the planned position of the autonomous vehicle in the environment at multiple future time points in a time window that starts at the current time point. For example, the planned trajectory can identify, at each of the multiple future time points, a planned spatial position in the environment that will be occupied by the vehicle at the future time point.

The system generates, using a behavior prediction system, a conditional trajectory prediction for the target agent (step 206). For example, the conditional trajectory prediction can include multiple candidate future trajectories and a respective likelihood score for each candidate future trajectory that represents the likelihood that the candidate future trajectory will be the actual future trajectory that is followed by the target agent assuming that the vehicle follows the planned trajectory.

Each candidate predicted trajectory identifies the predicted position of the target agent in the environment at multiple future time points in a time window that starts at the current time point. The time window for the predicted trajectory can be the same length as or can be shorter than the time window for the planned trajectory.

In particular, the system generates the trajectory prediction conditioned on (i) the scene data characterizing the scene at the current time point and (ii) the planned trajectory of the autonomous vehicle.

In some implementations, the system generates the conditional trajectory prediction by causing the behavior prediction system to generate the trajectory prediction for the first agent based on the planned trajectory for the autonomous vehicle instead of based on a predicted trajectory for the autonomous vehicle generated by the behavior prediction system.

As described above, the behavior prediction system can predict, for each agent in the scene, multiple candidate future trajectories and a respective likelihood score for each candidate future trajectory that represents the likelihood that the candidate future trajectory will be the actual future trajectory that is followed by the agent. The behavior prediction system can make this prediction by generating an initial representation of the future motion of each agent (including the autonomous vehicle), e.g., based on motion planning algorithms applied to the agent's current trajectory, likelihood models of the agent's future motion given the agent's current trajectory, and so on, and then generating the trajectory predictions based on the initial representations.

To cause the behavior prediction system to generate a conditional behavior prediction, the system replaces the initial representation for the autonomous vehicle with an initial representation that indicates that there is a 100% likelihood that the planned future trajectory will be followed by the autonomous vehicle.

In other words, when generating the trajectory prediction for the target agent, the system causes the behavior prediction system to replace the trajectory prediction for the autonomous vehicle with the planned trajectory for the autonomous vehicle.

By generating the prediction in this manner, the system effectively conditions the trajectory prediction on the entire planned trajectory without increasing the computational complexity and resource consumption of generating the prediction. However, generating the trajectory prediction in this manner assumes that the target agent has access to the entire planned trajectory of the autonomous vehicle when, in practice, the target agent can only observe the planned trajectory as it occurs.

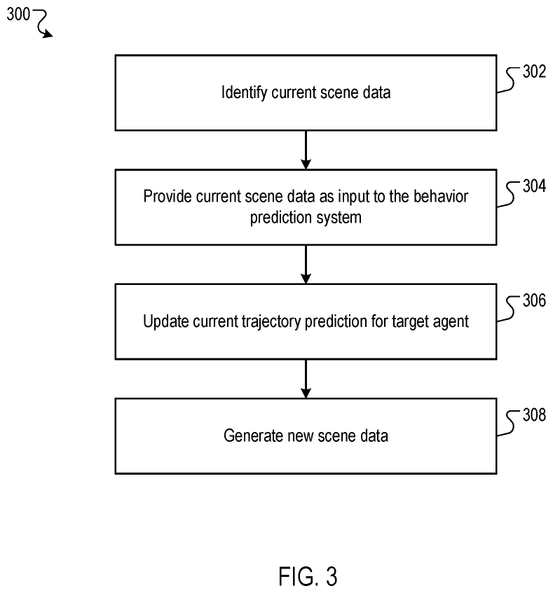

FIG. 3 is a flow diagram of another example process 300 for generating conditional behavior prediction data for a target agent. For convenience, the process 300 will be described as being performed by a system of one or more computers located in one or more locations. For example, an on-board system, e.g., the on-board system 100 of FIG. 1, appropriately programmed in accordance with this specification, can perform the process 300.

The system can perform the process 300 for each of multiple candidate planned trajectories that are generated by a planning system of the autonomous vehicle to generate respective conditional behavior prediction data for each of the multiple candidate planned trajectories. The planning system can then use the conditional behavior prediction data for the different candidate trajectories to select a final planned trajectory, i.e., by selecting one of the candidates or by determining not to select any of the candidate planned trajectories.

The system can perform the process 300 for each of multiple consecutive time intervals within the predicted trajectory to iteratively generate the conditional behavior prediction data for the target agent. In particular, the first time interval starts at the current time point and the last time interval ends at the end of the predicted trajectory.

As described above, the trajectory prediction that needs to be generated defines the predicted position of the autonomous vehicle in the environment at multiple future time points in a time window that starts at the current time point. For example, each predicted trajectory in the trajectory prediction can be a sequence of coordinates, with each coordinate in the sequence corresponding to one of the future time points and representing a predicted position of the vehicle at the corresponding future time point.

In some cases, each of the time intervals corresponds to a different one of these future time points. In other cases, to reduce the number of iterations of the process 300 that need to be performed in order to generate the trajectory prediction, each time interval corresponds to multiple ones of the future time points.

The system identifies scene data characterizing a current scene as of the beginning of the current time interval (step 302).

For the first time interval, the current scene is the scene at the current time point.

For each time interval that is after the first time interval, the current scene is the scene after the preceding iteration of the process 300, i.e., that is generated by simulating the scene as of the beginning of the previous time interval as described below.

The system provides the scene data characterizing the current scene as input to the behavior prediction system (step 304). The behavior prediction system then generates trajectory predictions for all of the agents in the scene, including the target agent, starting from the beginning of the current time interval.

In these cases, the system does not modify the operation of the behavior prediction system, i.e., does not modify the behavior prediction system to directly consider the planned trajectory of the autonomous vehicle.

In some implementations, the behavior prediction system re-generates the predictions for all of the agents in the scene at each time interval. In some other implementations, to increase the computational efficiency of the process, the behavior prediction system only re-generates the trajectory for the target agent and re-uses the trajectory predictions for the other agents from the previous time interval.

As described above, the trajectory prediction for each agent can include multiple candidate future trajectories and a respective likelihood score for each candidate future trajectory that represents the likelihood that the candidate future trajectory will be the actual future trajectory that is followed by the agent.

The system updates the current trajectory prediction for the target agent (step 306). In particular, the system replaces the portion of the current trajectory prediction that starts at the beginning of the current time interval with the corresponding portion of the new trajectory prediction for the target agent.

For each iteration of the process 300 other than the one corresponding to the final time interval, the system generates scene data that characterizes the scene as of the end of the current time interval, i.e., the beginning of the next time interval (step 308).

In particular, for each agent in the scene other than the autonomous vehicle, the system extends the historical data for that agent, i.e., the historical data that is in the scene data characterizing the scene as of the beginning of the current time point, to indicate that the agent followed the trajectory prediction for the agent over the current time interval. In particular, for each agent, the system can select the trajectory with the highest likelihood score from the most recently generated trajectory prediction for the agent, and then extend the historical data for that agent to indicate that the agent followed the selected trajectory for the agent over the current time interval.

For the autonomous vehicle, instead of using the predicted trajectory, the system extends the historical data for the autonomous vehicle to indicate that the vehicle followed the planned trajectory over the current time interval. Thus, the system simulates each agent other than autonomous vehicle to follow the (most recent) predicted trajectory for the agent and then extends the historical data with the corresponding simulated future states of each agent.

Thus, when simulating the current scene at any given point, the system uses the predicted trajectories generated by the behavior prediction system for agents other than the autonomous vehicle while using the planned trajectory generated by the planning system for simulating the trajectory for the autonomous vehicle.

In some implementations, prior to performing the process 300 for any of the time intervals, the system can determine whether the most recent predicted trajectory, e.g., the trajectory with highest score in the most recent trajectory prediction for the autonomous vehicle, i.e., the trajectory prediction generated at the preceding iteration of the process 300, is significantly different from the planned trajectory starting from the beginning of the current time interval. If the predicted and planned trajectories are significantly different, the system can perform the iteration of the process 300 in order to update the trajectory prediction for the target agent (and generate a new predicted trajectory for the autonomous vehicle). If the predicted and planned trajectory are not significantly different, the system can refrain from performing any more iterations of the process 300 and use the trajectory prediction of the target agent as the final trajectory prediction for the target agent for the current and any remaining time intervals in the future time period that are after the current time interval.

The system can determine that two trajectories are significantly different when a distance measure between the two trajectories exceeds a threshold. For example, the distance measure can be based on, e.g., equal to or directly proportional to, the sum of the distances between the coordinates at corresponding time points in the two trajectories.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining scene data characterizing a scene in an environment at a current time point, wherein the scene includes at least a first agent and an autonomous vehicle navigating through the environment;
obtaining data identifying a set of one or more planned trajectories of the autonomous vehicle navigating through an environment, wherein each planned trajectory is generated by a planning system of the autonomous vehicle, and wherein each planned trajectory identifies a planned path of the autonomous vehicle through the environment subsequent to the current time point; and
generating, using a behavior prediction system and for each planned trajectory in the set, a conditional trajectory prediction for the first agent subsequent to the current time point conditioned on (i) the data characterizing the scene at the current time point and (ii) the planned trajectory of the autonomous vehicle.

2. The method of claim 1, wherein the conditional trajectory prediction includes a plurality of candidate future trajectories for the first agent and a respective likelihood score for each candidate future trajectory that represents a likelihood that the first agent will follow the candidate future trajectory if the autonomous vehicle follows the planned trajectory.

3. The method of claim 1, wherein the behavior prediction system generates a trajectory prediction for an input agent in a scene in the environment that also includes one or more other agents by generating respective initial representation of future motion for each of the other agents and generating the trajectory prediction for the input agent based on the respective initial representations for the other agents.

4. The method of claim 3, wherein generating the conditional trajectory prediction of the first agent comprises:
causing the behavior prediction system to generate the trajectory prediction for the first agent based on the planned trajectory for the autonomous vehicle instead of based on an initial representation for the autonomous vehicle generated by the behavior prediction system.

5. The method of claim 1, wherein the environment scene data includes historical data characterizing an actual trajectory of each of the agents in the scene.

6. The method of claim 1, wherein the conditional future trajectory prediction includes predictions for a respective position of the first agent at multiple future time points subsequent to the current time point, and wherein the generating, using the behavior prediction system, the trajectory prediction of the first agent subsequent to the current time point comprises, for each of a plurality of time intervals that each include one or more future time points between the current time point and a final future time point in the trajectory prediction:
identifying current scene data characterizing a current scene as of a beginning of the time interval;
generating, using the behavior prediction system, updated trajectory predictions starting from the beginning of the time interval for each of the agents in the environment;
updating a current trajectory prediction for the first agent based on the updated trajectory prediction for the first agent; and
updating the current scene data to characterize a scene in which (i) each agent other than the autonomous vehicle followed the updated trajectory prediction for the agent over the time interval and (ii) the autonomous vehicle followed the planned trajectory for the autonomous vehicle for the time interval.

7. The method of claim 6, wherein each time interval corresponds to a plurality of future time points.

8. The method of claim 6, further comprising:
determining that the updated trajectory prediction for the autonomous vehicle is significantly different than the planned trajectory for the autonomous vehicle, and wherein the identifying, generating, and updating are performed only in response to the determining.

9. The method of claim 6, wherein, for a first time interval that starts at a current time point, the current scene data is the scene data, and for each other time interval, the current scene is the updated current scene data for a preceding time interval.

10. The method of claim 1, further comprising:
providing the conditional trajectory predictions to the planning system for use in selecting a final planned trajectory for the autonomous vehicle.

11. A system comprising:
one or more computers; and
one or more storage devices storing instructions that, when executed by the one or more computers, cause the one or more computers to perform operations comprising:
obtaining scene data characterizing a scene in an environment at a current time point, wherein the scene includes at least a first agent and an autonomous vehicle navigating through the environment;
obtaining data identifying a set of one or more planned trajectories of the autonomous vehicle navigating through an environment, wherein each planned trajectory is generated by a planning system of the autonomous vehicle, and wherein each planned trajectory identifies a planned path of the autonomous vehicle through the environment subsequent to the current time point; and
generating, using a behavior prediction system and for each planned trajectory in the set, a conditional trajectory prediction for the first agent subsequent to the current time point conditioned on (i) the data characterizing the scene at the current time point and (ii) the planned trajectory of the autonomous vehicle.

12. The system of claim 11, wherein the conditional trajectory prediction includes a plurality of candidate future trajectories for the first agent and a respective likelihood score for each candidate future trajectory that represents a likelihood that the first agent will follow the candidate future trajectory if the autonomous vehicle follows the planned trajectory.

13. The system of claim 11, wherein the behavior prediction system generates a trajectory prediction for an input agent in a scene in the environment that also includes one or more other agents by generating respective initial representation of future motion for each of the other agents and generating the trajectory prediction for the input agent based on the respective initial representations for the other agents.

14. The system of claim 13, wherein generating the conditional trajectory prediction of the first agent comprises:
causing the behavior prediction system to generate the trajectory prediction for the first agent based on the planned trajectory for the autonomous vehicle instead of based on an initial representation for the autonomous vehicle generated by the behavior prediction system.

15. The system of claim 11, wherein the environment scene data includes historical data characterizing an actual trajectory of each of the agents in the scene.

16. The system of claim 11, wherein the conditional future trajectory prediction includes predictions for a respective position of the first agent at multiple future time points subsequent to the current time point, and wherein the generating, using the behavior prediction system, the trajectory prediction of the first agent subsequent to the current time point comprises, for each of a plurality of time intervals that each include one or more future time points between the current time point and a final future time point in the trajectory prediction:
identifying current scene data characterizing a current scene as of a beginning of the time interval;
generating, using the behavior prediction system, updated trajectory predictions starting from the beginning of the time interval for each of the agents in the environment;
updating a current trajectory prediction for the first agent based on the updated trajectory prediction for the first agent; and
updating the current scene data to characterize a scene in which (i) each agent other than the autonomous vehicle followed the updated trajectory prediction for the agent over the time interval and (ii) the autonomous vehicle followed the planned trajectory for the autonomous vehicle for the time interval.

17. The system of claim 16, wherein each time interval corresponds to a plurality of future time points.

18. The system of claim 16, the operations further comprising:
determining that the updated trajectory prediction for the autonomous vehicle is significantly different than the planned trajectory for the autonomous vehicle, and wherein the identifying, generating, and updating are performed only in response to the determining.

19. The system of claim 16, wherein, for a first time interval that starts at a current time point, the current scene data is the scene data, and for each other time interval, the current scene is the updated current scene data for a preceding time interval.

20. One or more non-transitory computer-readable storage media storing instructions that when executed by one or more computers cause the one or more computers to perform operations comprising:
obtaining scene data characterizing a scene in an environment at a current time point, wherein the scene includes at least a first agent and an autonomous vehicle navigating through the environment;
obtaining data identifying a set of one or more planned trajectories of the autonomous vehicle navigating through an environment, wherein each planned trajectory is generated by a planning system of the autonomous vehicle, and wherein each planned trajectory identifies a planned path of the autonomous vehicle through the environment subsequent to the current time point; and
generating, using a behavior prediction system and for each planned trajectory in the set, a conditional trajectory prediction for the first agent subsequent to the current time point conditioned on (i) the data characterizing the scene at the current time point and (ii) the planned trajectory of the autonomous vehicle.
